(19) United States
(12) Patent Application Publication
(10) Pub. No.: US 2003/0030762 A1
(43) Pub. Date: Feb. 13, 2003

(54) Reflective- Type liquid crystal display

(76) Inventors: Yuan Wen Liu, Tainan (TW); Kuang Lung Tsai, Hsinchu (TW)

Correspondence Address: BIRCH STEWART KOLASCH & BIRCH, PO BOX 747, FALLS CHURCH, VA, 22040-0747, US

(21) Appl. No.: 09/986,185

(22) Filed: Nov. 7, 2001

(30) Foreign Application Priority Data
Aug. 8, 2001 (TW) 90119365

(51) Int. Cl. G02F 1/1335

(52) U.S. Cl. 349/61

(57) ABSTRACT

A reflective-type liquid crystal display is disclosed. The reflective-type liquid crystal display comprises an outer frame, a liquid crystal display panel mounted within the outer frame and a movable cold cathode flat fluorescent lamp disposed on the outer frame by a connecting element to provide a light source to the liquid crystal display.

### BACKGROUND OF THE INVENTION

1. Field of the Invention

The present invention relates to a display device having a light source, more particularly, to a reflective-type liquid crystal display having a flat lamp serving as the supplementary light source. The flat lamp can be easily switched on to provide a light source to the reflective-type liquid crystal display when the ambient light is insufficient. In addition, it can be switched off when the ambient light is sufficient, thus saving power.

2. Description of the Related Art

Liquid crystal displays are widely used in portable electrical products such as electrical calculators, personal digital assistants (PDA), and e-book viewers. A supplementary light source must be applied to the liquid crystal display when the ambient light is insufficient. There are typically two light sources, a front-light and backlight. The front-light source employs a particular light guide film capable of transmitting the ambient light to the liquid crystal display panel, and reflecting the light from a lamp adjacent to the light guide film to the liquid crystal display panel. Because the light guide film can be inefficient, the lamp power supply needs to be frequently charged.

The backlight source comprises a lamp disposed on the rear of the liquid crystal display panel, and a specified diffusion film to diffuse the light from a backlight lamp into the liquid crystal display panel and reflect the ambient light. However, it is very difficult to optimize the transmissivity and the reflectivity of a backlight module. This can result in power supply loss for the backlight module.

### SUMMARY OF THE INVENTION

In view of the above disadvantages, an object of the invention is to provide a reflective-type liquid crystal display using a flat lamp as the supplementary light source. The flat lamp can be easily switched on to provide a light source to the reflective-type liquid crystal display when the ambient light is insufficient, and can be switched off when the ambient light is sufficient to save power.

Accordingly, the above objects are attained by providing a reflective-type liquid crystal display comprising an outer frame, a liquid crystal display panel mounted within the outer frame, and a flat lamp disposed on the outer frame by a connecting element to provide a light source to the liquid crystal display.

In an embodiment of the invention, the flat lamp comprises a tube-shaped lamp and a light guide film or a spot-shaped lamp and light guide film. Preferably. the flat lamp is a cold cathode flat fluorescent lamp, having superior brightness, uniformity, long life, cool operation, and off-the-shelf availability.

The flat lamp is also connected to the outer frame as a movable flat lamp, preferably pivotally.

Moreover, in another embodiment of the invention, the reflective-type liquid crystal display comprises a storage space such as a slot under the outer frame for placing the flat lamp.

Furthermore, the reflective-type liquid crystal display, preferably a color liquid crystal display panel, further comprises a diffusing film and/or enhanced-brightness film on the upper surface of the flat lamp.

The above objects are also attained by providing a reflective-type liquid crystal display, comprising: an outer frame; a liquid crystal display panel mounted within the outer frame; and a movable cold cathode flat fluorescent lamp disposed on the outer frame by a connecting element to provide a light source to the liquid crystal display.

According to the invention, the reflective-type liquid crystal display has a flat lamp serving as the supplementary light source. The flat lamp can be easily switched on to provide a light source to the reflective-type liquid crystal display when the ambient light is insufficient. It can also be switched off when the ambient light is sufficient to save power.

Also, according to the invention, the reflective-type liquid crystal display is suitable for a variety of electrical products.

### BRIEF DESCRIPTION OF THE DRAWINGS

The preferred embodiment of the invention is hereinafter described with reference to the accompanying drawings in which:

FIG. 1 is a perspective view of a reflective-type liquid crystal display having a flat lamp in use, according to the preferred embodiment of the invention.

FIG. 2 is a perspective view of a reflective-type liquid crystal display having a flat lamp not in use, according to the preferred embodiment of the invention.

### DETAILED DESCRIPTION OF THE PREFERRED EMBODIMENTS

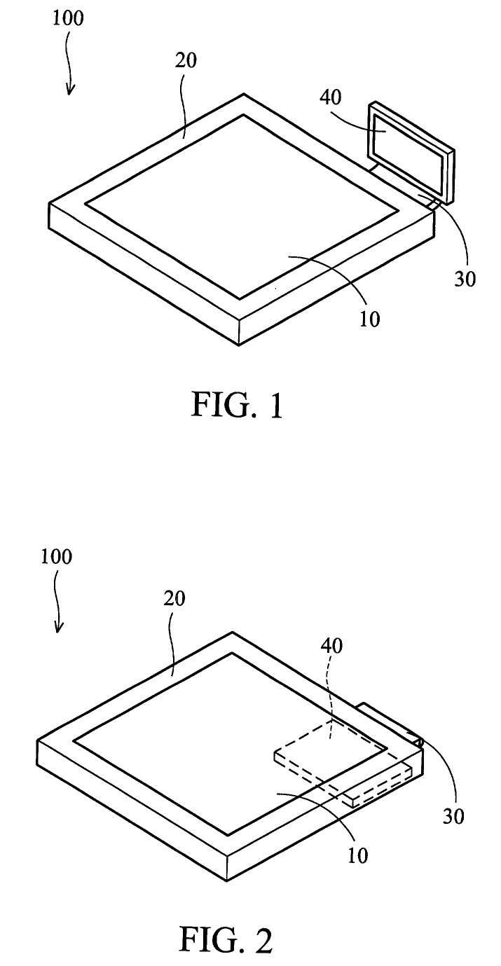

The following description explains the preferred embodiment of the invention, with reference to the accompanying FIG. 1 and FIG. 2.

FIG. 1 shows a reflective-type liquid crystal display 100, for example in a PDA. The liquid crystal display 100 comprises an outer frame 20, and a liquid crystal display panel 10, mounted within the outer frame 20.

The commercial off-the-shelf cold cathode flat fluorescent lamp 40 emits uniform white light. The lamp 40 contains three wavelength phosphors, red/green/blue (R/G/B), suitable for the color liquid crystal display.

The connecting element 30, such as a hinge, disposes the cold cathode flat fluorescent lamp 40 on the outer frame 20 for pivotal movement. As shown in FIG. 1, the cold cathode flat fluorescent lamp 40 is switched on to provide extra light to the liquid crystal display panel 10.

Referring to FIG. 2, when ambient light is sufficient, the cold cathode flat fluorescent lamp 40 is switched off and is disposed in a storage space, such as a slot (not shown).

While the embodiment describes a commercial off-the shelf cold cathode flat fluorescent lamp 40, a tube-shaped or spot-shaped kit with a light guide film can be used to replace the cold cathode flat fluorescent lamp 40.

While the embodiment also describes the cold cathode flat fluorescent lamp 40 as mounted on the outer frame 20 for pivotal movement, it can be fixed on the outer frame 20.

To enhance the performance of the cold cathode flat fluorescent lamp 40, diffusing film and/or enhanced-brightness film can alternatively be attached on the emitting surface of the cold cathode flat fluorescent lamp 40.

While the invention has been described with reference to various illustrative embodiments, the description is not intended to be construed in a limiting sense. Various modifications of the illustrative embodiments, as well as other embodiments of the invention, will be apparent to those person skilled in the art upon reference to this description. It is therefore contemplated that the appended claims will cover any such modifications or embodiments as may fall within the scope of the invention defined by the following claims and their equivalents.

What is claimed is

1. A reflective-type liquid crystal display, comprising:
an outer frame;
a liquid crystal display panel mounted within the outer frame; and
a flat lamp disposed on the outer frame by a connecting element to provide a light source to the liquid crystal display.

2. A reflective-type liquid crystal display as claimed in claim 1, wherein the flat lamp comprises a tube-shaped lamp and a light guide film.

3. A reflective-type liquid crystal display as claimed in claim 1, wherein the flat lamp comprises a spot-shaped lamp and a light guide film.

4. A reflective-type liquid crystal display as claimed in claim 1, wherein the flat lamp is a cold cathode flat fluorescent lamp.

5. A reflective-type liquid crystal display as claimed in claim 1, wherein the flat lamp is moveably connected to the outer frame.

6. A reflective-type liquid crystal display as claimed in claim 5, wherein the flat lamp is pivotally connected to the outer frame.

7. A reflective-type liquid crystal display as claimed in claim 6, further comprising a storage space under the outer frame for the flat lamp.

8. A reflective-type liquid crystal display as claimed in claim 7, wherein the storage space is a slot.

9. A reflective-type liquid crystal display as claimed in claim 1, further comprising a diffusing film on the upper surface of the flat lamp.

10. A reflective-type liquid crystal display as claimed in claim 1, further comprising an enhanced-brightness film on the upper surface of the flat lamp.

11. A reflective-type liquid crystal display as claimed in claim 1, further comprising a diffusing film and an enhanced-brightness film on the upper surface of the flat light.

12. A reflective-type liquid crystal display as claimed in claim 1, wherein the liquid crystal display panel is a color liquid crystal display panel.

13. A reflective-type liquid crystal display, comprising:
an outer frame;
a liquid crystal display panel mounted within the outer frame; and
a movable cold cathode flat fluorescent lamp disposed on the outer frame by a connecting element to provide a light source to the liquid crystal display.

14. A reflective-type liquid crystal display as claimed in claim 13, wherein the flat fluorescent lamp is pivotally connected to the outer frame.

15. A reflective-type liquid crystal display as claimed in claim 13, further comprising a storage space under the outer frame for the flat fluorescent lamp.

16. A reflective-type liquid crystal display as claimed in claim 15, wherein the storage space is a slot.

17. A reflective-type liquid crystal display as claimed in claim 13, wherein the liquid crystal display panel is a color liquid crystal display panel.
